(19) United States
(12) Patent Application Publication
(10) Pub. No.: US 2025/0253469 A1
(43) Pub. Date: Aug. 7, 2025

(54) PROTECTIVE DEVICE, ENERGY-STORE PROTECTIVE DEVICE, PROTECTIVE SYSTEM, METHOD FOR PRODUCING A PROTECTIVE SYSTEM, METHOD FOR PRODUCING A MOTOR VEHICLE, AND MOTOR VEHICLE

(71) Applicant: ElringKlinger AG, Dettingen (DE)

(72) Inventors: Eugen KÜBLER, Dettingen/Erms (DE); Matthias BIEGERL, Dettingen/Erms (DE)

(73) Assignee: ElringKlinger AG, Dettingen (DE)

(21) Appl. No.: 19/189,506

(22) Filed: Apr. 25, 2025

Related U.S. Application Data
(63) Continuation of application No. PCT/EP2023/079694, filed on Oct. 25, 2023.

(30) Foreign Application Priority Data
Oct. 28, 2022 (DE) 10 2022 128 714.9

(51) Int. Cl. H01M 50/242; B60K 1/04; B60L 50/60; B60R 19/56; H01M 50/227; H01M 50/249

(52) U.S. Cl. CPC H01M 50/242; H01M 50/227; H01M 50/249; B60K 1/04; B60K 2001/0438; B60L 50/60; B60R 19/56; H01M 2220/20

(57) ABSTRACT

A protective device (100) for arranging on an impact-sensitive element (102), for example on a battery element (106), wherein the protective device (100) comprises the following: a wall element (108) and an adaptation element (116) arranged on the wall element (108).

### RELATED APPLICATION

This application is a continuation of international application No. PCT/EP 2023/079694 filed on Oct. 25, 2023, and claims the benefit of German application No. 10 2022 128 714.9 filed on Oct. 28, 2022, which are incorporated herein by reference in their entirety and for all purposes.

### FIELD OF DISCLOSURE

The present invention relates to the field of protective devices for arrangement on battery elements which are used in particular to drive motor vehicles.

### BACKGROUND

In electrically driven motor vehicles, the battery cells are commonly arranged in battery cell modules and battery devices are constructed from the battery cell modules. A battery device includes many battery cell modules. The battery cell modules in turn comprise many battery cells. The battery devices are often installed in a battery housing in the underbody of the motor vehicle.

A battery cell module comprises multiple battery cells, which are usually connected in series, a cell contact system, a module housing, a cooling system, a BMS module unit of the battery management system (BMS) and a cabling system. The BMS is responsible for monitoring and controlling the entire battery device. At the module level, BMS module units provide the so-called “balancing”, which means the charge compensation of the cells of the module.

The use of battery cell modules has to date been preferred, as it primarily offered advantages in configuration and assembly. This allowed the number of modules to be varied, thus ensuring easy scalability. There was no need to fundamentally change the basic structure of the battery device if larger or smaller battery devices were assembled from the battery cell modules.

To boost the energy density and thus the range of motor vehicles, there are efforts underway to no longer install the battery cells in the form of battery cell modules, but instead to integrate the battery cells directly into a (single) battery cell pack and to accommodate this pack in a battery cell housing. If battery cells are integrated directly into battery cell packs without first grouping the battery cells into battery cell modules and then grouping the battery cell modules into battery cell devices in housings, this is called “cell-to-pack” technology (CTP).

Clearly, the integration of battery cells into battery cell packs that is a characteristic of CTP technology renders superfluous many passive materials that are not directly involved in energy storage, such as module housings. This allows a better utilization of space within the battery device and hence ultimately a higher volumetric and/or gravimetric energy density and range can be achieved.

In addition, efforts are underway to integrate the battery cells directly into the chassis of the motor vehicle. The intention here is to omit not only the battery cell modules that have been usual to date, but also the battery housing that is still provided for in the cell-to-pack technology. Efforts to integrate the battery cells directly into the chassis are assembled under the umbrella term “cell-to-chassis” (CTC). The term “chassis” refers to the load-bearing parts of the motor vehicle. These are also referred to as frame or underframe. An advantage of CTC technology is that further passive materials that are not directly involved in energy storage can be omitted, thereby enabling a further boost to the energy density.

CTP technology and CTC technology pose particular challenges for the protection of battery cells from mechanical damage, which may be caused for instance by stone chipping, by debris thrown up or driven over, or by accidents. These technologies, indeed, very largely omit module housings and possibly even battery housings.

By means of the CTP or CTC designs, hitherto usual cross-struts within housings are omitted in favour of further battery cells. This can lead to the absence of attachment points and/or supporting elements for, for example, an underrun protection device which may be used to protect the battery cells from stone chipping. This can result in very large free bending lengths for the underrun protection device. The large free bending lengths could be compensated by the design of the underrun protection device, for example by an increased wall thickness or reinforced materials with a higher elasticity modulus, for example with reinforcing carbon fibers, or by more installed deformation space. This is undesirable, since increased wall thicknesses result in higher masses and materials for underrun protection devices with a higher elasticity modulus, for example with reinforcing carbon fibers, are associated with increased costs. An increased installed deformation space is also undesirable, as this means that more installation space has to be provided for the deformation of the underrun protection device, which in turn reduces the installation space available for the battery cells. This applies not only to the underrun protection device but also, analogously, to other protective devices that are used to protect battery cells.

### SUMMARY OF THE INVENTION

It is an object of the present invention to provide a motor vehicle, a protective system intended for the motor vehicle and a protective device intended for the motor vehicle, whereby the range of the motor vehicle can be further boosted with the minimum of production effort.

The object is achieved by the protective device of the invention in accordance with the relevant independent claim.

It is a protective device for arrangement on an impact-sensitive element.

The impact-sensitive element is for example a battery element.

The battery element may be a battery cell, a battery cell module, a battery cell pack or a battery device.

The battery device may comprise multiple battery cell modules. Each battery cell module may comprise multiple battery cells.

The battery element may preferably be a battery cell pack of a battery device. The battery cell pack may comprise advantageously at least 10%, in particular at least 15%, preferably at least 20%, further preferably at least 25%, especially preferably at least 35%, most preferably at least 50% of the battery cells which are provided for the drive in a motor vehicle. The battery cells included in the battery cell pack are advantageously not divided over different battery cell modules. The battery cells included in the battery cell pack are preferably not divided over different housings, for example module housings.

The device may preferably be a protective device for arrangement on a battery cell pack.

It may preferably be a protective device for arrangement on a battery cell.

The battery cell may be a round cell, a prismatic cell or a pouch cell.

If it is a protective device for arrangement on a battery cell, the battery cell may preferably be a round cell or a prismatic cell. This may be advantageous since then a force acting on the battery element and originating from the adaptation element does not lead to deformation of the battery element. Round cells and prismatic cells are known to be stable, whereas the pouches of the pouch cells could be deformed by a force originating from the adaptation element.

The protective device comprises a wall element.

A suitable wall element is any wall element that withstands the mechanical loads from which the impact-sensitive element is to be protected. If the protective device is an underrun protection device, the mechanical loads may be, for example, the loads typically encountered on stone chipping in road traffic.

The wall element may be, for example, a plastics wall element or a metal wall element. A plastics wall element comprises a plastics wall. A metal wall element comprises a metal wall.

The plastics wall element may be a fiber-reinforced plastics wall element. At least some of the fibers may be integrated in the plastics wall. At least some of the fibers may be arranged on a surface of the plastics wall. At least some of the fibers may be glass fibers, carbon fibers or polymer fibers, for example.

The protective device comprises an adaptation element arranged on the wall element.

The adaptation element may be arranged directly or indirectly on the wall element. An adaptation element arranged directly on the wall element may be attached to the wall element or arranged on the wall element, for example via an intermediate element, for example an intermediate layer.

The adaptation element may preferably be compressible from an initial extension to a target extension. This may in particular enable the adaptation element, in the case of arrangement of the protective device on the battery element, to be compressed by a surface of the battery element pressing on the adaptation element during the mounting of the protective device and compressing the adaptation element in the process.

The adaptation element may preferably comprise an adaptation material. The adaptation material may be, for example, a layered adaptation material.

The adaptation element may consist of the adaptation material.

The adaptation material may be arranged directly or indirectly on the wall element.

The adaptation material may have apertures. The apertures may, for example, extend into the adaptation material from a surface of the adaptation material that faces away from the wall element.

The apertures may extend into the surface of the adaptation material that faces away from the wall element, so that the adaptation material has recesses that do not pass right through the adaptation material. The apertures may alternatively extend from the surface of the adaptation material that faces away from the wall element right through the adaptation material.

Some of the apertures may extend into the surface of the adaptation material that faces away from the wall element, so that the adaptation material has recesses that do not pass right through the adaptation material. Some other of the apertures may extend from the surface of the adaptation material that faces away from the wall element right through the adaptation material.

Preferably at least some of the apertures may be entirely surrounded by adaptation material.

The layered adaptation material may be an open layered adaptation material or a closed layered adaptation material. An open layered adaptation material may have a lattice structure or a honeycomb structure, for example.

An open layered adaptation material is characterized in that apertures extend right through the adaptation material, for example up to a surface of the wall element. A closed layered adaptation material has no apertures extending right through the adaptation material.

The adaptation material may preferably be a foam material or a nonwoven material. The adaptation material may be a foam material, for example.

The layered adaptation material may preferably be a foam material or a nonwoven material. The layered adaptation material may be a foam material, for example.

The foam material may be a plastics foam material. The plastic of the plastics foam material may preferably contain at least one polyalkene, polyamide, and/or polyimide.

The polyalkene may preferably be a polypropene (PP).

The polyamide may preferably be a PA6 or a PA6.6, for example a PA6. PA6 is known to stand for polycaprolactam. PA6.6 is known to stand for the polymer of hexamethylenediamine and adipic acid, each containing a chain of 6 carbon atoms.

The polyimide may preferably be a polymethacrylimide (PMI).

Further suitable plastics foam materials are known to experts.

The adaptation material, for example the layered adaptation material, may preferably be an adaptation precursor material.

The adaptation precursor material may be, for example, a foam precursor material.

The foam precursor material is preferably a foamable material. The foamable material may be physically or chemically foamable.

Preferably, the foam precursor material can be converted by foaming into a compressible adaptation material described herein. Suitable materials that are physically or chemically foamable are familiar to experts.

The adaptation element may comprise a thermally reshapable adaptation material. The thermally reshapable adaptation material may be a material that can be converted to a soft state by heating.

This may be particularly advantageous since the thermally reshapable adaptation material is reshaped to a desired degree on attachment of the protective device to the impact-sensitive element and, after cooling, a calibrated dimension of the adaptation element is set. The calibrated dimension derives from the attachment of the protective device to the impact-sensitive element.

As described herein, the adaptation material may have apertures. This also applies to the thermally reshapable adaptation material. This may be particularly advantageous since apertures in the thermally reshapable adaptation material can fill up partially with the adaptation material during reshaping at the moment of the mounting of the protective device on the impact-sensitive element.

For example, the adaptation element may comprise an adaptation element strand extending along the wall element, said strand comprising a thermally reshapable adaptation material.

The adaptation element strand may be an adaptation element rib, for example.

The adaptation element strand or the adaptation element rib may extend along an aperture of the adaptation material. The adaptation element strand or the adaptation element rib may form part of a honeycomb structure or lattice structure of the adaptation element.

It is particularly preferable if the adaptation element comprises the adaptation material and a cover, wherein the adaptation material is arranged between the wall element and the cover.

The cover is preferably flexible. The cover may comprise a film, for example a plastics film, and/or a nonwoven semi-finished product, in particular a plastic-nonwoven semi-finished product. The cover may preferably be a film, for example a plastics film, and/or a nonwoven semi-finished product, in particular a plastic-nonwoven semi-finished product.

In particular, the cover may be made of the same material as the adaptation material. It can be made entirely or partially of the same material as the adaptation material. It may be particularly advantageous if it is made entirely of the same material as the adaptation material.

This may bring about or facilitate a materially bonded connection of the cover to the adaptation material and thus ultimately reduce the production cost and complexity. In addition, the recyclability can be improved as a result, because the cover does not need, or only partially needs, to be detached from the adaptation material for this purpose.

The cover may afford the particular advantage that in the event of repair, the protective device can be removed together with the entire adaptation element, including the cover, and thus the battery element which can be protected by the protective device can be accessible.

Without the cover, a connection of the adaptation element to the surface of the impact-sensitive element could arise when mounting the protective device on the impact-sensitive element, for example the battery element, as a result of which repair to the impact-sensitive element, for example the battery element, could be rendered significantly more difficult or even impossible. Such a connection could arise in particular if the adaptation element comprises the soft thermally reshapable adaptation material or in the case of the described foaming.

The cover may be flat and continuous or may have at least one opening.

Preferably, the cover may have an attachment opening and the adaptation material in the attachment opening may define an attachment zone, wherein the adaptation material is preferably a foam precursor material or a thermally reshapable adaptation material.

If the cover has an attachment opening and the adaptation material in the attachment opening defines an attachment zone, a materially bonded or form-fitting connection can thereby be generated to components of a motor vehicle which reach up to the attachment zone.

The cover may preferably adhere on the adaptation material.

It may be preferable if the adaptation element is a spring element. The spring element may preferably be a shaped spring element.

The shaped spring element may preferably be made of steel sheet or steel strip, for example spring steel sheet or spring steel strip.

The spring element may preferably be a curved flat spring element.

The flat spring element may be curved in a connecting zone from which there extend two extension zones splayed relative to one another.

A length measured along a main extension direction of the flat spring element may be greater than a width of the flat spring element as measured from the extension zone along the connecting zone into the other extension zone.

It may be preferable if at least two, in particular at least three, for example at least four extension zones, starting from one or more connecting zones, extend parallel to each other.

The extension zones extending parallel to each other may be spaced apart by apertures, preferably by slitlike apertures.

By stating that the extension zones extend parallel to each other, it is meant that the extension zones relative to one another adopt an angle of at most 30°, in particular at most 20°, for example at least 15°.

A plurality of extension zones extending parallel to each other may jointly define a contact face on which the impact-sensitive element can be positioned spaced apart from the wall element.

For example, a contact zone of the impact-sensitive element may come to lie on the contact face.

It may be preferable if at least one extension zone of the flat spring element extends into a supporting zone. A resilient bridge zone may preferably be present between the connecting zone and the supporting zone. The impact-sensitive element may preferably come to lie on the bridge zone. It may be particularly preferable if the contact zone of the impact-sensitive element comes to lie on the bridge zone.

It may be particularly preferable if the protective device comprises a further adaptation element arranged on the wall element, where the impact-sensitive element can be positioned on the adaptation elements spaced apart from the wall element.

The further adaptation element may be a further spring element, preferably a further shaped spring element, for example a further curved flat spring element. It may be preferable if at least two contact zones of the impact-sensitive element can be positioned on the adaptation elements.

It may be particularly preferable if the main extension directions of at least two adaptation elements which are arranged on the wall element run parallel to each other. The main extension directions run parallel to each other if they have preferably an angle of at most 30°, particularly preferably an angle of at most 20°, very preferably an angle of at most 15° to each other.

It may be advantageous if a receiving space is defined on the wall element between the adaptation elements, for example flat spring elements, wherein a receiving region of the impact-sensitive element that protrudes beyond the contact zones of the impact-sensitive element can extend into the receiving space if the contact zones of the impact-sensitive element come to lie on the adaptation elements, for example flat spring elements.

The protective device may be an energy store protective device for a motor vehicle. The protective device may in particular be an underrun protection device for a motor vehicle. The energy store protective device or underrun protection device may comprise a protective device described herein or consist of a protective device described herein.

It may be particularly preferable if the energy store protective device or the underrun protection device comprises a floor section and a wall section.

The wall section and the floor section may be sections of the wall element.

The wall element may transition in a floor-to-wall transition from the floor section to the wall section.

At least one part of the wall section may run with an incline relative to at least one part of the floor section.

This may be particularly advantageous since the wall section of the protective device can protect the impact-sensitive element, for example the battery element, from mechanical loads acting from a first direction (for example from in front or from the side) and the floor section can protect the impact-sensitive element, for example the battery element, from mechanical loads acting from a second direction (for example from below).

Preferably there is at least one adaptation element described herein arranged on the floor section. Alternatively or additionally, at least one adaptation element described herein may be arranged preferably on a wall section described herein.

It is possible for an adaptation element described herein to be arranged on a wall section and on a floor section and to extend via the floor-to-wall transition from the wall section to the floor section.

The object is also achieved by the protective system of the invention in accordance with the relevant independent claim.

The protective system may be an underrun protection system, for example.

The protective system comprises the impact-sensitive element already described in connection with the protective device.

The protective system comprises the protective device. The protective device is arranged on the impact-sensitive element.

The impact-sensitive element may preferably be arranged on the adaptation element and at the same time spaced apart from the wall element. In this arrangement, the wall element may be so close to the impact-sensitive element that the adaptation element is compressed, prestressed and/or reshaped.

The adaptation element may preferably be compressed, prestressed and reshaped or have only two of these properties or have only one of these properties.

If an adaptation material comprised by the adaptation element is, for example, a foam material, the adaptation element may in particular be compressed.

If the adaptation element is a spring element, the adaptation element may in particular be prestressed.

If the adaptation element comprises a thermally reshapable adaptation material, the adaptation element may in particular be reshaped.

An adapted surface of the adaptation element may advantageously extend along a surface of the impact-sensitive element.

The adapted surface of the adaptation element may preferably extend along a surface contour of the impact-sensitive element.

Different impact-sensitive elements, for example different battery elements, have different surface contours. If the battery element is a battery cell or a battery cell pack, the features of the surface contour may include electrical conductors via which electrical current can be supplied to the battery element or via which electrical current can be drawn from the battery element.

If the adapted surface of the adaptation element extends along the surface contour of the impact-sensitive element, this may have or promote the effect that the impact-sensitive element can be substantially no longer displaced on the surface of the adaptation element. Securement of the impact-sensitive element in the desired position can be brought about at least partially by a protective device, for example an underrun protection device. Such an effect has to date been achieved by additional components, which can now at least partially be omitted.

The protective device may preferably be arranged on the impact-sensitive element such that the adaptation element in an adaptation zone has an adapted thickness, which differs from a thickness of the adaptation element in a zone adjacent to the adaptation zone. The adapted thickness in the adaptation zone is preferably less than the thickness in the adjacent zone. This may also help to secure the position of the impact-sensitive element, for example battery element, and may produce the advantages described in connection with the adapted surface.

The adapted surface of the adaptation element may preferably comprise a positioning reliability zone. The positioning reliability zone may extend around an edge of the impact-sensitive element. If the positioning reliability zone extends around the edge of the impact-sensitive element, this likewise helps to secure the position of the impact-sensitive element, for example battery element, and this may likewise make it possible to bring about the advantages described in connection with the adapted surface.

It may be particularly advantageous if a surface of the cover described herein is arranged on the impact-sensitive element.

Especially in the event of repairs, this may result in advantages, which have already been described elsewhere in the present text.

There may advantageously be an offset between a surface zone of the adaptation element, said zone being arranged at an edge of the impact-sensitive element, and an adjacent surface zone of the adaptation element, said zone being spaced apart from the impact-sensitive element. In particular, the surface zone of the adaptation element, said zone being arranged at an edge of the impact-sensitive element, may be offset toward the wall element, relative to the adjacent surface zone of the adaptation element, said zone being spaced apart from the impact-sensitive element. This too may help the protective device to secure the position of the impact-sensitive element, for example battery element, and this may make it possible to bring about the advantages described in connection with the adapted surface.

The object is also achieved by a method of the invention for producing a protective system in accordance with the relevant independent claim.

The method may be a method for producing an underrun protection system.

In the method, a protective device is provided, wherein the protective device comprises a wall element and an adaptation element arranged on the wall element.

The protective device and an impact-sensitive element, for example a battery element, are brought into contact with each other. The battery element has been described in more detail in connection with the protective device. Of course, the information provided there may also apply in connection with the method of the invention.

In this case, the wall element is brought so close to the impact-sensitive element that the adaptation element is compressed, prestressed and/or reshaped. Alternatively, if the adaptation element comprises an adaptation precursor material, for example a foam precursor material, the wall element is brought to the impact-sensitive element and a thickness of the adaptation precursor material is increased to an extent such that the adaptation element comes into contact with the impact-sensitive element. The thickness of the adaptation precursor material can be increased, for example, by foaming of the foam precursor material to an extent such that the adaptation element comes into contact with the impact-sensitive element.

The adaptation element preferably comprises an adaptation material, wherein the adaptation material is a compressible or a thermally reshapable adaptation material and wherein the wall element is brought so close to the impact-sensitive element that the adaptation element is compressed, prestressed and/or reshaped.

The adaptation material may be, for example, a layered adaptation material. The compressible adaptation material may preferably be a foam material or a nonwoven material, for example a foam material.

Adaptation elements and adaptation materials are described in detail herein in connection with the protective device. Of course, the information provided there may also apply in connection with the method of the invention.

Preferably, the adaptation element may comprise a foam precursor material, the wall element may be brought to the impact-sensitive element and a thickness of the foam precursor material may be increased by foaming of the foam precursor material to an extent such that the adaptation element comes into contact with the impact-sensitive element.

Preferably, in the method, an adapted surface of the adaptation element is generated along a surface of the impact-sensitive element. For this purpose, the wall element may be brought so close to the impact-sensitive element that the adapted surface of the adaptation element is established along the surface of the impact-sensitive element. Alternatively, the thickness of the adaptation precursor material may be increased to such an extent that the adapted surface of the adaptation element is established along the surface of the impact-sensitive element.

In this case, the bringing of the wall element to the impact-sensitive element and/or the increasing of the thickness of the adaptation precursor material can be continued
until the adapted surface of the adaptation element extends along a surface contour of the impact-sensitive element; and/or
until the protective device is arranged on the impact-sensitive element such that the adaptation element in an adaptation zone has an adapted thickness, which differs from a thickness of the adaptation element in a zone adjacent to the adaptation zone, wherein the adapted thickness in the adaptation zone is preferably less than the thickness in the adjacent zone; and/or
until the adapted surface of the adaptation element comprises a positioning reliability zone, wherein the positioning reliability zone extends around an edge of the impact-sensitive element.

A surface of the impact-sensitive element that faces the protective device is preferably covered at least partially by a cover.

The cover is preferably flexible. The cover is, for example, a film and/or a nonwoven semi-finished product, in particular a plastic-nonwoven semi-finished product.

It may be advantageous if the adaptation element comprises the adaptation material and the cover, wherein the adaptation material is arranged between the wall element and the cover, wherein the impact-sensitive element is brought up to the cover or the cover up to the impact-sensitive element.

In particular if the adaptation material is the adaptation precursor material, for example the foam precursor material, the cover can be brought to the impact-sensitive element by an increase in the thickness of the adaptation precursor material.

Preferably, the cover may have an attachment opening and the adaptation material in the attachment opening may define an attachment zone, wherein the adaptation material is preferably a foam precursor material or a thermally reshapable adaptation material.

It may be preferable not to bring the impact-sensitive element and the attachment zone into contact with each other. In the event of repairs, this can have the advantage that the impact-sensitive element, for example the battery element, is not attached via the attachment zone to an adaptation material of the protective device. The protective device can then be removed without having to undo an (unwanted) connection to an impact-sensitive element, for example to a battery element.

Preferably, the adaptation element may be a spring element, in particular a shaped spring element, for example a curved flat spring element, and a contact zone may be arranged on the impact-sensitive element, wherein the wall element is brought so close to the impact-sensitive element that the contact zone comes to lie on the spring element and the spring element is compressed, prestressed and/or reshaped between the contact zone and the wall element.

In addition, a soft component may be mounted, in particular injection-molded, on the adaptation element, in particular on the spring element. The soft component may contain, for example, TTE and/or a thermoplastic elastomer and/or an elastomer. It can be used to protect an overlying impact-sensitive region-for example, to protect the impact-sensitive element.

The contact zone may be arranged set back on the impact-sensitive element. This may in particular mean that a surface of the impact-sensitive element that faces the wall element comes to lie closer to the wall element than the contact zone, which comes to lie on the spring element.

The surface of the impact-sensitive element that faces the wall element preferably comes to lie spaced apart from the wall element when the contact zone comes to lie on the spring element. There is preferably a buffer zone between the surface of the impact-sensitive element that faces the wall element and the wall element. This zone may allow elastic deformation of the wall element in the event of mechanical loading, for example stone chipping, so that the impact-sensitive element can be protected from the mechanical loading by the wall element and the buffer zone.

The spring element has been described in more detail in connection with the protective device. Of course, the information provided there may also apply correspondingly in connection with the method.

The object is also achieved by a method of the invention for producing a motor vehicle in accordance with the relevant independent claim.

The method for producing the motor vehicle may in particular comprise a method of the invention for producing a protective system.

Particularly preferably, a surface of the impact-sensitive element that faces the protective device can be covered at least partially by a cover.

The adaptation element may comprise the adaptation material and the cover, wherein the adaptation material is arranged between the wall element and the cover, wherein the impact-sensitive element is brought up to the cover or the cover is brought up to the impact-sensitive element. The cover may have an attachment opening and the adaptation material in the attachment opening may define an attachment zone. Preferably, the impact-sensitive element and the attachment zone are not brought into contact with each other.

In the method for producing the motor vehicle, the adaptation material can preferably be brought through the attachment zone into contact with a motor vehicle component, for example a load-bearing motor vehicle component, and the protective device can be held on the motor vehicle component via a connection of the adaptation material to the motor vehicle component.

The object is also achieved by a motor vehicle of the invention in accordance with the relevant independent claim.

The motor vehicle may preferably comprise a protective device described herein, an energy store protective device described herein and/or a protective system described herein. The protective system may preferably be a protective system obtained according to a method described herein for producing a protective system. The motor vehicle may preferably be a motor vehicle obtained according to a method described herein for producing a motor vehicle.

Preferably, the motor vehicle comprises a protective device described herein, wherein the impact-sensitive element is a battery element and wherein the battery element is a battery cell pack or a battery cell.

The battery element is preferably arranged in the chassis of the motor vehicle.

In the motor vehicle and in the method for producing the motor vehicle, the impact-sensitive element may preferably be a battery element described herein, for example a battery cell pack described herein or a battery cell described herein. The battery element, for example the battery cell pack described herein or the battery cell described herein, may preferably be arranged in the chassis.

The battery element, for example the battery cell pack described herein or the battery cell described herein, is preferably not surrounded in the chassis by a battery housing. This may be particularly advantageous since the wall element in conjunction with the adaptation element can then take over the function of the battery housing at least partially.

It is self-evident that features described in connection with one subject of the invention may also form features of another herein-described subject of the invention. Subjects of the invention are in particular the protective device, the energy store protective device, for example the underrun protection device, the protective system, for example the underrun protection system, the method for producing a protective system, the method for producing a motor vehicle, and the motor vehicle.

Further preferred features and/or advantages of the invention are the subject of the following description and the drawn representation of exemplary embodiments.

### BRIEF DESCRIPTION OF THE DRAWINGS

FIG. 1 shows a section through a schematically represented protective device;

FIG. 2 shows a section through a schematically represented protective system;

FIG. 3 shows a section through a schematically represented protective system under mechanical load;

FIG. 4 shows a section through a schematically represented protective device with adaptation precursor material;

FIG. 5 shows a section through a part of a motor vehicle with protective system in a schematic representation;

FIG. 6 shows an enlarged detail from FIG. 2;

FIG. 7 shows a section through a schematically represented protective device with thermally reshapable adaptation material;

FIG. 8 shows a section through a schematically represented protective system;

FIG. 9 shows a section through a further schematically represented protective system;

FIG. 10 shows a section through an underrun protection system;

FIG. 11 shows a battery suspension element with a battery element in a schematic sectional representation;

FIG. 12 shows an underrun protection device in a schematic sectional representation;

FIG. 13 shows a section through a protective system;

FIG. 14 shows a schematic sectional representation of a protective system with spring element;

FIG. 15 shows two shaped spring elements, which can be used as an adaptation element, in a perspective representation;

FIG. 16 shows a schematic sectional representation of a protective device with thermally reshapable adaptation elements; and

FIG. 17 shows a protective system with thermally reshaped adaptation elements.

Identical or functionally equivalent elements are provided with the same reference signs in all the figures.

### DETAILED DESCRIPTION OF THE DRAWINGS

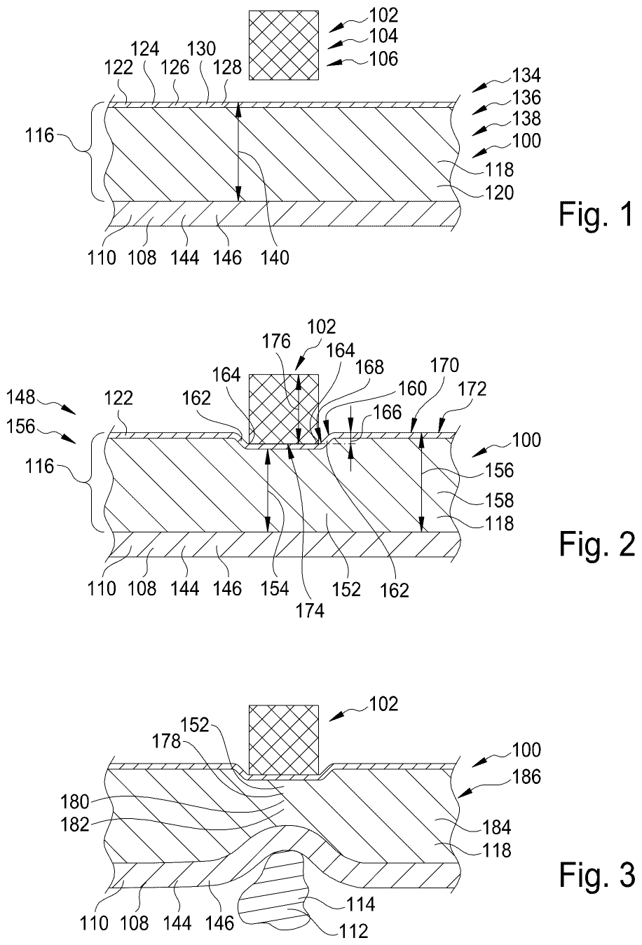

FIG. 1 shows a protective device 100 for arrangement on an impact-sensitive element 102. The impact-sensitive element is an energy store element 104. The energy store element 104 is a battery element 106.

The protective device 100 comprises a wall element 108. The wall element 108 can serve as a shield 110 to protect the impact-sensitive element 102 from colliding bodies 112, such as stones 114 or curb edges.

The protective device comprises an adaptation element 116 arranged on the wall element 108. The adaptation element 116 comprises a layered adaptation material 118. The layered adaptation material 118 is a foam material 120.

The adaptation element 116 also comprises a cover 122. The cover 122 is a film 124. The film 124 is a plastics film 126. The plastics film 126 is a top ply 128, which has been applied to the surface of the adaptation material 118 that faces away from the wall element 108. The top ply 128 forms a top layer 130 there.

In FIG. 1, as also in the following FIGS. 2 to 9, the impact-sensitive element 102 is shown only schematically as a rectangle. This represents a severe simplification. Typically, the impact-sensitive element 102 may be a battery element 106. The battery element 106 may be very small and, for example, may comprise or represent only one battery cell. Alternatively, the battery element may contain a multiplicity of battery cells and, for example, may be a battery cell pack 132 containing more than 100 battery cells. All these possibilities are intended to be covered by the schematic rectangular representation of the battery element in FIGS. 1 to 8.

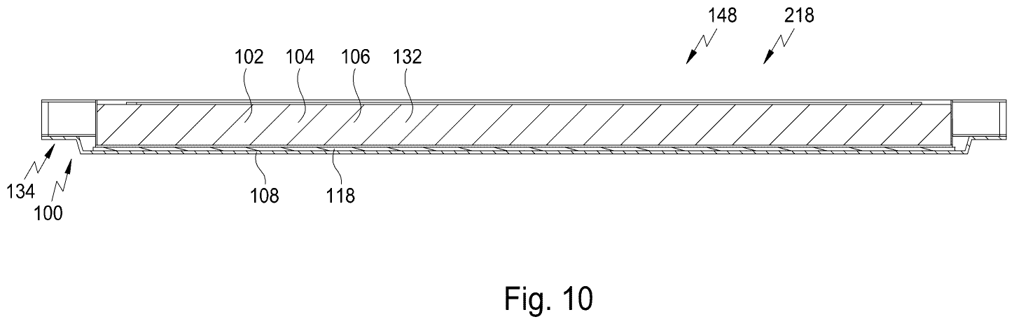

The protective device 100 may, for example, be an underrun protection device 134. Specific configurations of underrun protection devices 134 are represented in FIGS. 10 to 17.

As is evident in particular from the following observations on FIGS. 2 to 9, the protective device 100 can be conceived as a positioning device 136 or else as a receiving device 138.

In FIG. 1 it is likewise represented that the adaptation element 116, which comprises the adaptation material 118 and the cover 122, has an initial extension 140.

The wall element 108 acts as an adaptation element carrier 142. The wall element 108 forms a reinforcing layer 144 or a reinforcing ply 146.

FIG. 2 likewise shows the protective device 100 and the impact-sensitive element 102 from FIG. 1. The protective device 100 is arranged on the impact-sensitive element 102. FIG. 2 thus shows a protective system 148. Since the impact-sensitive element 102 is a battery element 106, this system is a battery protection system 150.

FIG. 2 shows that the impact-sensitive element 102 is arranged on the adaptation element 116. The impact-sensitive element 102 is arranged spaced apart from the wall element 108. The wall element 108 is brought so close to the impact-sensitive element 102 that the adaptation element 116 is compressed, prestressed and reshaped.

The protective device 100 is arranged on the impact-sensitive element 102 such that the adaptation element 116 in an adaptation zone 152 has an adapted thickness 154, which differs from a thickness 156 of the adaptation element 116 in a zone 158 adjacent to the adaptation zone 152. The adapted thickness 154 of the adaptation zone 152 is less than the thickness 156 in the zone 158. In the example represented here, an adapted surface 160 of the adaptation element 116 comprises a positioning reliability zone 162. The positioning reliability zone 162 extends around an edge 164 of the impact-sensitive element 102.

There is an offset 166 between a surface zone 168 of the adaptation element, said zone being arranged at an edge of the impact-sensitive element, and an adjacent surface zone 170 of the adaptation element 116, said zone being spaced apart from the impact-sensitive element.

The cover 122 has a surface 172 facing away from the wall element 108. The impact-sensitive element has a surface 174 facing the wall element 108.

FIG. 2 also represents a height 176 of the impact-sensitive element 102. The height 176 is measured orthogonal to the main extension direction of the wall element 108.

FIG. 3 illustrates an impact acting on the protective device 100. This is a schematic representation. In particular, the bending of the wall element 108 as a result of the impact is exaggerated. The strike of the stone 114 further compresses the adaptation material 118 in the adaptation zone 152. The adaptation zone 152 here then acts additionally as an impact absorption zone 178. It forms a buffer zone 180, which can also be conceived as a reinforcing zone 182. In this zone, the force acting substantially locally as a result of the stone 114 is distributed over a larger area. The adaptation material 118 thus acts here as an impact force distribution material 184. The layered adaptation material may therefore act as an impact force distribution layer 186, which protects the impact-sensitive element 102 from damage by the striking stone 114. Of course, the wall element 108 also acts as a shield here, so that the desired protective effect is achieved jointly by the wall element 108 and the adaptation material 118.

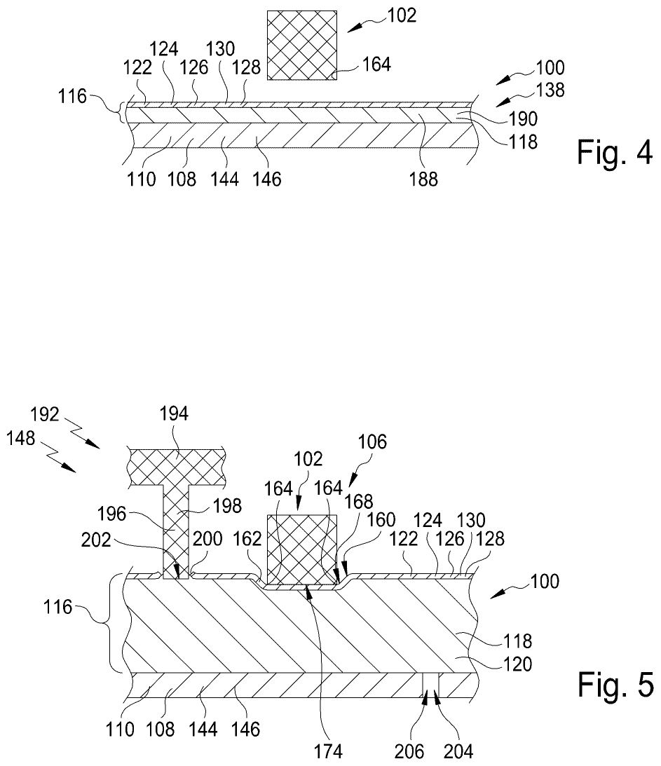

FIG. 4 likewise shows a protective device 100 and an impact-sensitive element 102.

The adaptation element 116 shown in FIG. 4 comprises an adaptation material 118. The adaptation material 118 is an adaptation precursor material 188. The adaptation precursor material 188 is a foam precursor material 190, which can be converted by foaming into a foam material 120.

By the foaming of the foam precursor material 190, an impact-sensitive element 102 can be received at its edge 164 partially by the protective device 100. The protective device 100 is therefore a receiving device 138.

FIG. 5 shows schematically a detail of a motor vehicle 192. A detail of a protective system 148 comprised by the motor vehicle 192 is represented. The protective system 148 comprises a protective device 100 and an impact-sensitive element 102.

The impact-sensitive element 102 is a battery element 106.

The motor vehicle 192 is an at least partially electrically driven motor vehicle 192, wherein at least a part of the electrical energy serving for the drive of the motor vehicle 192 is provided by the battery element 106.

The motor vehicle 192 comprises a carrier 194; the carrier 194 comprises an attachment element 196. In the example shown here, the attachment element 196 is a rib 198.

The protective device 100 comprises a wall element 108 and an adaptation element 116. The adaptation element 116 comprises an adaptation material 118 and a cover 122.

The cover 122 has an attachment opening 200. The adaptation material 118 is a foam material 120 obtained by foaming a foam precursor material 190. The adaptation material 118 defines in the attachment opening 200 an attachment zone 202.

The adaptation material 118 is in contact through the attachment zone 202 with the attachment element 196, which is a load-bearing motor vehicle component. The protective device 100 is thus held on a load-bearing motor vehicle component via a connection of the adaptation material 118 to the attachment element 196.

FIG. 5 also shows that the wall element 108 has a feed opening 204. A feed zone 206 extends through the feed opening 204. Through the feed opening 204, the foam precursor material 190 was introduced between the cover 122 and the wall element 108 via the feed zone 206 during production of the protective device shown in FIG. 5, prior to the foaming.

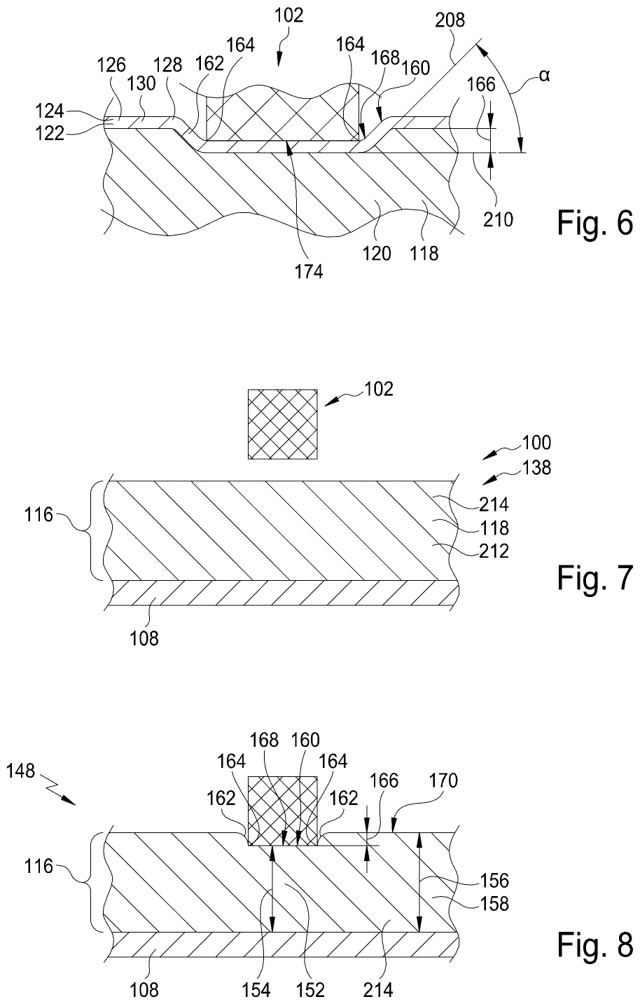

FIG. 6 shows an enlarged detail from FIG. 2. In the section represented, the profile of the cover in the region of the adapted surface 160 at the edge 164 is approximated by a straight line 208. This straight line occupies the angle alpha to a straight line 210 running parallel to the wall element 108.

FIG. 7 shows a protective device 100 and an impact-sensitive element 102.

The protective device 100 comprises a wall element 108 and an adaptation element 116. The adaptation element 116 comprises a thermally reshapable adaptation material 118. The thermally reshapable adaptation material 118 is a thermoplastic material 212. The adaptation element 116 is an adaptation rib 214.

For production of the protective system 148, the thermally reshapable adaptation material 118 can be preheated so much that it is reshaped when the impact-sensitive element impinges on the surface of the thermally reshapable adaptation material 118. This is represented in FIG. 8.

FIG. 8 shows a protective system 148 which comprises a wall element 108 and an adaptation element 116. The adaptation element 116 comprises the thermally reshapable adaptation material 118 already described in connection with FIG. 7.

As a result of the reshaping of the adaptation rib by the impact-sensitive element 102, the adapted thickness 154 in the adaptation zone 152 is less than the thickness 156 in the adjacent zone 158.

Here too, the adapted surface 160 of the adaptation element 116 comprises a positioning reliability zone 162, wherein the positioning reliability zone 162 extends around an edge 164 of the impact-sensitive element 102. There is an offset 166 between a surface zone 168 of the adaptation element 116, said zone being arranged at an edge 164 of the impact-sensitive element 102, and an adjacent surface zone 170 of the adaptation element 116, said zone being spaced apart from the impact-sensitive element 102.

As has already been explained, battery elements 106 may have extremely different constructions and may, for example, constitute only one battery cell or a large multiplicity of battery cells which are combined to form a battery cell pack 132. This can result in extremely different surface contours 216 which may be present at the surface 174.

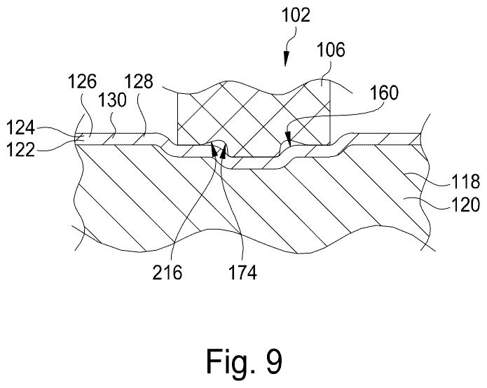

FIG. 9 schematically shows a surface contour 216 of a battery element 106. FIG. 9 clearly shows that an adapted surface 160 of the adaptation element 116 extends along a surface 174 of the impact-sensitive element 102, i.e., of the battery element 106. The adapted surface 160 of the adaptation element 116 extends along the surface contour 216 of the impact-sensitive element 102, i.e., of the battery element 106.

FIGS. 10 to 17 illustrate specific configuration options for protective devices 100 in the form of underrun protection devices 134.

FIG. 10 shows an underrun protection device 134. The underrun protection device 134 comprises a wall element 108. It also comprises an adaptation material 118.

FIG. 10 also shows an impact-sensitive element 102. The impact-sensitive element 102 is an energy store element 104. It is a battery element 106, which in the example shown here is implemented as a battery cell pack 132, wherein the battery cell pack is represented only schematically. The protective device 100 together with the impact-sensitive element 102 forms a protective system 148. The underrun protection device 134 together with the battery cell pack 132 forms an underrun protection system 218.

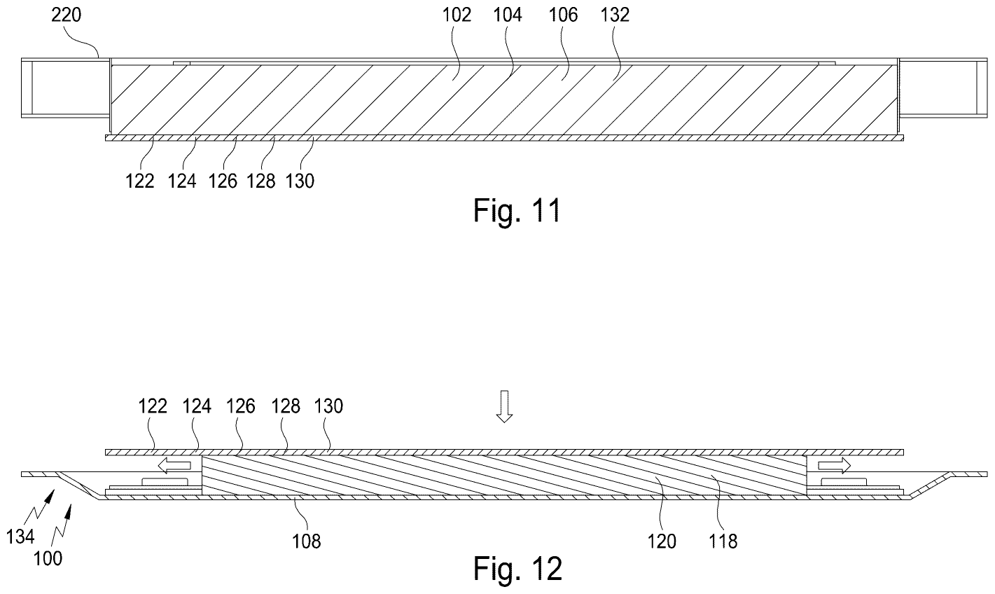

FIG. 11 shows a battery cell pack 132 arranged in a battery suspension element 220. The cover 122 is represented additionally. The cover 122 is a film 124 in the form of a plastics film 126, which can act as a top ply 128 or top layer 130.

FIG. 12 shows the underrun protection device 134 shown in FIG. 10 in installed condition. The adaptation material 118 is a foam material 120. In FIG. 12, the foam material 120 is not yet compressed by the battery cell pack 132. In addition, the foam material 120 occupies only a part of the area which it occupies after compression by the battery cell pack 132. The arrows pointing to the left and right in FIG. 12 indicate that a pressure acting from above, exerted by the battery cell pack 132, leads to spreading of the foam material 120 on the wall element 108.

On insertion of the battery cell pack 132, which is represented in FIG. 11, into the underrun protection device 134, which is represented in FIG. 12, the cover 122 is inserted between the battery cell pack 132 and the foam material 120. FIG. 11 illustrates the possibility of first arranging the cover 122 on the battery cell pack 132. FIG. 12 illustrates the possibility of arranging the cover 122 on the foam material 120 of the underrun protection device 134. It is possible to inject the foam material between the cover 122 and the wall element 108 through a feed opening, not shown here, which, for example, can pass through the wall element 108.

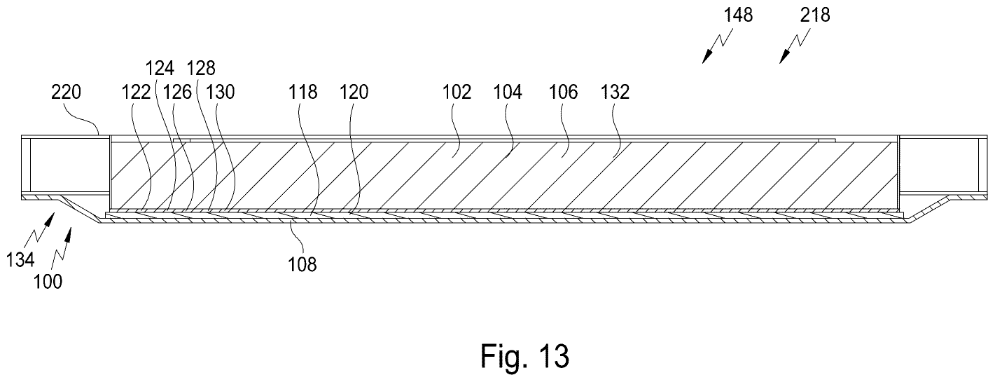

FIG. 13 shows a further underrun protection system 218 which is produced with an underrun protection device 134. The battery cell pack 132 inserted into the underrun protection device 134 is arranged on a battery suspension element 220. The underrun protection device 134 comprises a wall element 108. It further comprises an adaptation element. FIG. 13 shows the adaptation material 118, which is comprised by the adaptation element. The adaptation material 118 is a foam material 120. The adaptation element further comprises a cover 122. The cover 122 is arranged between the battery cell pack 132 and the foam material 120.

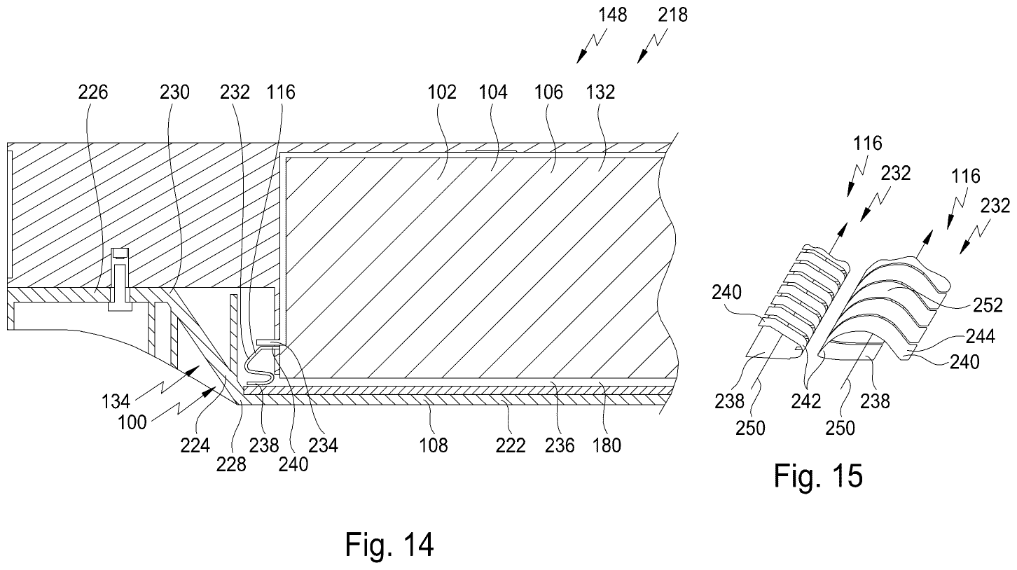

FIG. 14 shows a detail of a further underrun protection device 134, which is a further specific configuration of the protective device 100. The protective device 100 comprises a wall element 108. The wall element 108 comprises a floor section 222, a wall section 224 and an attachment edge section 226. The floor section 222 transitions into the wall section 224 in a floor-to-wall transition 228. The wall section transitions into the attachment edge section 226 in an attachment edge-to-wall transition 230.

The wall section extends at an incline to the floor section 222 and to the attachment edge section 226. The floor section 222 extends at an offset to the attachment edge section 226, wherein the floor section 222 and the attachment edge section 226 are aligned substantially parallel to each other.

The underrun protection device 134 comprises an adaptation element 116 arranged on the wall element 108. The adaptation element 116 is a shaped spring element 232.

The impact-sensitive element 102 is also a battery cell pack 132 in the example shown here. On the impact-sensitive element 102, a contact zone 234 is formed. The impact-sensitive element 102, i.e., the battery cell pack 132, is positioned on the shaped spring element 232 spaced apart from the wall element 108. This can be seen from the cavity 236, which forms a buffer zone 180.

Battery cell pack 132 and underrun protection device 134 together form an underrun protection system 218.

FIG. 15 shows possibilities for the configuration of the shaped spring elements 232 provided in the underrun protection system 218 from FIG. 14. FIG. 15 shows two different shaped spring elements 232. The shaped spring element shown on the left in FIG. 15 comprises a first extension zone 238 and a second extension zone 240. The two extension zones 238 and 240 extend in the same direction starting from a connecting zone 242. The extension zone 238 extends spaced apart from the extension zone 240.

When the extension zones 238 and 240 are moved toward each other, a restoring force is built up that splays the two extension zones, thereby achieving the desired spring effect.

In the case of the shaped spring element 232 shown on the right in FIG. 15, the extension zone 240 is longer than the extension zone 238. The extension zone 240 extends into a supporting zone 244. In the extension zone 240, the shaped spring element 232 is bent to such an extent that the supporting zone 244 can come to lie together with the extension zone 238 on a planar surface, if the two extension zones 238 and 240 are moved toward each other or else if the shaped spring element 232 is in a relaxed, i.e., not prestressed, state.

Between the connecting zone 242 and the supporting zone 244 is a resilient bridge zone 252.

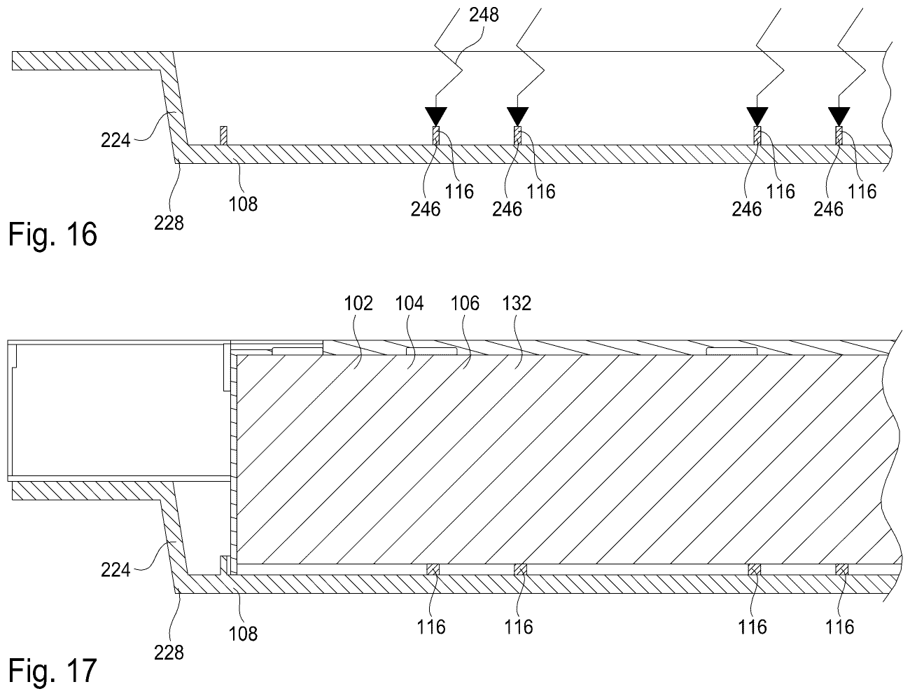

In the case of the underrun protection device 134 shown in FIG. 16, the adaptation elements 116 arranged on the wall element 108 are thermally reshapable. The adaptation elements 116 comprise a thermally reshapable adaptation material 246. The thermally reshapable adaptation material 246 can be converted into a reshapable state by heat 248, which is indicated in FIG. 16 by arrows. This was described in more detail above in connection with FIGS. 7 and 8.

FIG. 17 shows the underrun protection device which is shown in FIG. 16, with a battery cell pack 132 received therein. It can be seen that the adaptation elements 116 in FIG. 17 are wider as a result of the reshaping by the inserted battery cell pack 132.

### LIST OF REFERENCE SIGNS

100 Protective device
102 Impact-sensitive element
104 Energy store element
106 Battery element
108 Wall element
110 Shield
112 Body
114 Stone
116 Adaptation element
118 Adaptation material
120 Foam material
122 Cover
124 Film
126 Plastics film
128 Top ply
130 Top layer
132 Battery cell pack
134 Underrun protection device
136 Positioning device
138 Receiving device
140 Initial extension
142 Adaptation element carrier
144 Reinforcing layer
146 Reinforcing ply
148 Protective system
150 Battery protection system
152 Adaptation zone
154 Adapted thickness
156 Thickness
158 Zone
160 Adapted surface
162 Positioning reliability zone
164 Edge
166 Offset
168, 170 Surface zone
172, 174 Surface
176 Height
178 Impact absorption zone
180 Buffer zone
182 Reinforcing zone
184 Impact force distribution material
186 Impact force distribution layer
188 Adaptation precursor material
190 Foam precursor material
192 Motor vehicle
194 Carrier
196 Attachment element
198 Rib
200 Attachment opening
202 Attachment zone
204 Feed opening
206 Feed zone
208, 210 Straight line
212 Thermoplastic material
214 Adaptation rib
216 Surface contour
218 Underrun protection system
220 Battery suspension element
222 Floor section
224 Wall section
226 Attachment edge section
228 Floor-to-wall transition
230 Attachment edge-to-wall transition
232 Shaped spring element
234 Contact zone
236 Cavity
238, 240 Extension zone
242 Connecting zone
244 Supporting zone
246 Thermally reshapable adaptation material
248 Heat
250 Main extension direction
252 Bridge zone

1. A protective device for arrangement on an impact-sensitive element or on a battery element, wherein the protective device comprises the following:
a wall element and
an adaptation element arranged on the wall element.

2. The protective device as claimed in claim 1, wherein the adaptation element comprises an adaptation material or a layered adaptation material.

3. The protective device as claimed in claim 2, wherein the adaptation material or the layered adaptation material, is a compressible adaptation material or a foam material or a nonwoven material or a foam material.

4. The protective device as claimed in claim 2, wherein the adaptation material or the layered adaptation material, is an adaptation precursor material or a foam precursor material.

5. The protective device as claimed in claim 1, wherein the adaptation element comprises a thermally reshapable adaptation material.

6. The protective device as claimed in claim 2, wherein the adaptation element comprises
the adaptation material and
a cover,
wherein the adaptation material is arranged between the wall element and the cover.

7. The protective device as claimed in claim 6, wherein the cover is flexible.

8. The protective device as claimed in claim 6, wherein the cover is or comprises a film and/or a nonwoven semi-finished product and/or a plastic-nonwoven semi-finished product.

9. The protective device as claimed in claim 6, wherein the cover has an attachment opening and the adaptation material in the attachment opening defines an attachment zone, wherein the adaptation material is a foam precursor material or a thermally reshapable adaptation material.

10. The protective device as claimed in claim 1, wherein the adaptation element is a spring element or a shaped spring element or a curved flat spring element.

11. The protective device as claimed in claim 10, wherein the protective device comprises the following:
a further adaptation element arranged on the wall element, wherein the further adaptation element is a further spring element or a further shaped spring element or a further curved flat spring element,
wherein the impact-sensitive element can be positioned on the adaptation elements spaced apart from the wall element.

12. An energy store protective device, or underrun protection device, for a motor vehicle, comprising or consisting of said protective device as claimed in claim 1.

13. A protective system, comprising:
an impact-sensitive element or a battery element, and
protective device as claimed in claim 1, which is arranged on the impact-sensitive element.

14. A protective system as claimed in claim 13, wherein the impact-sensitive element is arranged on the adaptation element and in this arrangement is spaced apart from the wall element, wherein the wall element is brought so close to the impact-sensitive element that the adaptation element is compressed, prestressed and/or reshaped.

15. The protective system as claimed in claim 13, wherein an adapted surface of the adaptation element extends along a surface of the impact-sensitive element, wherein
the adapted surface of the adaptation element extends along a surface contour of the impact-sensitive element; and/or
the protective device is arranged on the impact-sensitive element such that the adaptation element in an adaptation zone has an adapted thickness, which differs from a thickness of the adaptation element in a zone adjacent to the adaptation zone; and/or
the adapted surface of the adaptation element comprises a positioning reliability zone, wherein the positioning reliability zone extends around an edge of the impact-sensitive element.

16. The protective system as claimed in claim 13, wherein a surface of the cover is arranged on the impact-sensitive element.

17. The protective system as claimed in claim 13, wherein there is an offset between a surface zone of the adaptation element, said zone being arranged at an edge of the impact-sensitive element, and an adjacent surface zone of the adaptation element, said zone being spaced apart from the impact-sensitive element.

18. A method for producing a protective system or an underrun protection system, as claimed in claim 13,
wherein
a protective device is provided, the protective device comprising the following:
a wall element and
an adaptation element arranged on the wall element,
the protective device and an impact-sensitive element or a battery element, are brought into contact with each other,
wherein the wall element is brought so close to the impact-sensitive element that the adaptation element is compressed, prestressed and/or reshaped,
or
wherein the adaptation element comprises an adaptation precursor material or a foam precursor material, the wall element is brought to the impact-sensitive element and a thickness of the adaptation precursor material is increased, by foaming of the foam precursor material, to an extent such that the adaptation element comes into contact with the impact-sensitive element.

19. The method as claimed in claim 18, wherein the adaptation element comprises an adaptation material or a layered adaptation material, wherein the adaptation material or the layered adaptation material, is a compressible adaptation material or a foam material or a nonwoven material or a thermally reshapable adaptation material, and
wherein the wall element is brought so close to the impact-sensitive element that the adaptation element is compressed, prestressed and/or reshaped.

20. The method as claimed in claim 18, wherein
the adaptation element comprises a foam precursor material, the wall element is brought to the impact-sensitive element and a thickness of the foam precursor material is increased by foaming of the foam precursor material to an extent such that the adaptation element comes into contact with the impact-sensitive element.

21. The method as claimed in claim 18, wherein a surface of the impact-sensitive element that faces the protective device is covered at least partially by a cover, wherein the cover is flexible, wherein the cover is a film.

22. The method as claimed in claim 21, wherein the adaptation element comprises
the adaptation material and
the cover,
wherein the adaptation material is arranged between the wall element and the cover, and
wherein the impact-sensitive element is brought up to the cover or the cover is brought up to the impact-sensitive element.

23. The method as claimed in claim 21, wherein the cover has an attachment opening and the adaptation material in the attachment opening defines an attachment zone, wherein the adaptation material is a foam precursor material or a thermally reshapable adaptation material.

24. The method as claimed in claim 23, wherein the impact-sensitive element and the attachment zone are not brought into contact with each other.

25. The method as claimed in claim 18, wherein the adaptation element is a spring element or a shaped spring element or a curved flat spring element, and on the impact-sensitive element a contact zone is arranged,
wherein the wall element is brought so close to the impact-sensitive element that the contact zone comes to lie on the spring element and the spring element between the contact zone and the wall element is compressed, prestressed and/or reshaped.

26. A method for producing a motor vehicle, comprising a method for producing a protective system or an underrun protection system, as claimed in claim 13,
wherein
a protective device is provided, the protective device comprising the following:
a wall element and
an adaptation element arranged on the wall element,
the protective device and an impact-sensitive element or a battery element, are brought into contact with each other,
wherein the wall element is brought so close to the impact-sensitive element that the adaptation element is compressed, prestressed and/or reshaped,
or
wherein the adaptation element comprises an adaptation precursor material or a foam precursor material, the wall element is brought to the impact-sensitive element and a thickness of the adaptation precursor material is increased, by foaming of the foam precursor material, to an extent such that the adaptation element comes into contact with the impact-sensitive element.
